(19) United States
(12) Patent Application Publication
(10) Pub. No.: US 2006/0200430 A1
(43) Pub. Date: Sep. 7, 2006

(54) TAXIMETER AND METHOD FOR CALCULATING CAP FARE USING NAVIGATION SYSTEM

(76) Inventor: DONG JO KIM, Icheon-shi Kyungki-do (KR)

Correspondence Address: IPLA P.A., 3580 WILSHIRE BLVD., 17TH FLOOR, LOS ANGELES, CA, 90010, US

(21) Appl. No.: 11/164,681

(22) Filed: Dec. 1, 2005

(30) Foreign Application Priority Data
Mar. 7, 2005 (KR) 10-2005-0018633

(51) Int. Cl. G07B 13/04

(52) U.S. Cl. 705/417

(57) ABSTRACT

A taximeter and method for calculating a cap fare using a navigation system is provided. The taximeter includes a GPS (global positioning system) module having a speed sensor to measure a speed, and receiving position information and absolute time information, calculating a self position, and outputting the calculated position, the time information, and the speed; a map database for storing map data; an input unit for generating a fare calculation start command, a fare calculation end command, and character data; a controller for mapping the calculated position to the map data, counting a time based on the time information, and accumulating a cap fare based on the counted time and the speed until receipt of the fare calculation end command; and a display unit for displaying the accumulated cap fare.

### BACKGROUND OF THE INVENTION

1. Field of the Invention

The present invention relates to a navigation system, and more particularly, to a taximeter and method for calculating a cap fare using a navigation system.

2. Description of the Related Art

In general, a taximeter is a device installed at a taxi and calculating a cap fare. The cap fare is calculated using a moving distance and a moving time and therefore, the taximeter should have the knowledge of a running speed, a running distance, and a running time in order to calculate the moving distance. Accordingly, the taximeter requires separate sensor and measurement device for measuring the running speed and the running distance.

Taxies equipped with the taximeters are in a trend of employing a global positioning system (Hereinafter, referred to as “GPS”) for managing a minicab and a navigation system for showing the way for guidance convenience.

Therefore, the conventional taxi has a drawback of installing the taximeter and the GPS at a front panel of a taxi interior, thereby causing complication of the taxi interior, and increasing a cost taken to purchase and install a plurality of devices.

### SUMMARY OF THE INVENTION

Accordingly, the present invention is directed to a taximeter and method for calculating a cap fare using a navigation system that substantially overcome one or more of the limitations and disadvantages of the conventional art.

One object of the present invention is to provide a taximeter and method for calculating and displaying a cap fare using a navigation system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a taximeter using a navigation system, the taximeter including: a GPS (global positioning system) module having a speed sensor to measure a speed, and receiving position information and absolute time information from each of a plurality of GPS satellites, calculating a self position, and outputting the calculated position, the time information, and the speed; a map database for storing map data; an input unit for generating a fare calculation start command, a fare calculation end command, and character data; a controller for mapping the calculated position to the map data, and upon receipt of the fare calculation start command, counting a time based on the time information, and accumulating a cap fare based on the counted time and the speed until receipt of the fare calculation end command; and a display unit for displaying the accumulated cap fare.

In another aspect of the present invention, there is provided a method for calculating a cap fare of a taximeter using a navigation system having a GPS (global positioning system) module having a speed sensor to measure a speed, and receiving position information and absolute time information from each of a plurality of GPS satellites, calculating a self position, and outputting the calculated position, the time information, and the speed; a map database for storing map data; an input unit for generating a fare calculation start command, a fare calculation end command, and character data; and a display unit for displaying predetermined mapped map data and the accumulated cap fare, the method including the steps of: upon receipt of a fare calculation command from the input unit, calculating a running time based on the counted time; measuring a running speed through the GPS module; upon measurement of the running speed, calculating a running distance based on the measured running speed and the counted time; calculating a cap fare based on the running distance and the running time; and displaying the calculated cap fare.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of a taximeter using a navigation system according to an embodiment of the present invention; and

FIG. 2 is a flowchart illustrating a method for calculating a cap fare of a taximeter using a navigation system according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention is to calculate a moving distance and a moving time using a speed sensor, modify absolute time information and self positions received from global positioning system (GPS) satellites in a navigation system, calculate an expected cap fare and an actual cap fare to a destination based on the moving distance and the moving time, and display the calculated expected cap fare and actual cap fare.

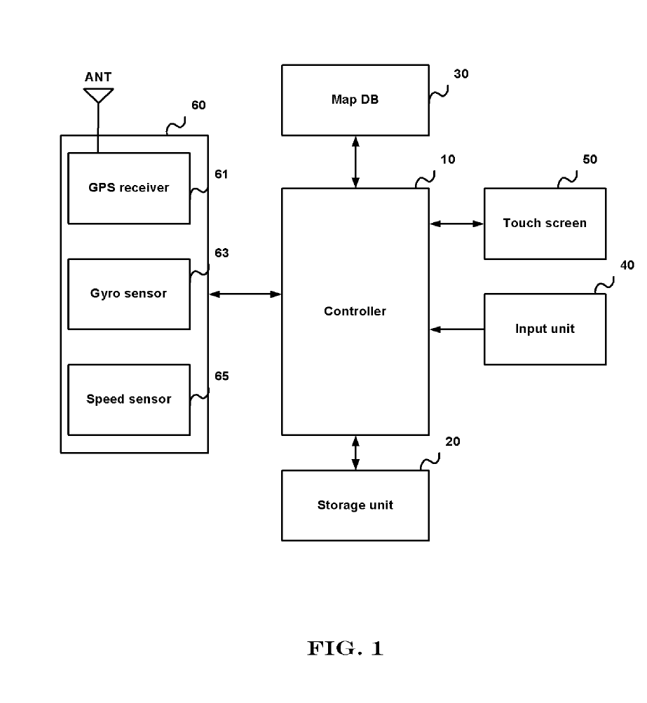

FIG. 1 illustrates a construction of a taximeter using the navigation system according to an embodiment of the present invention.

The inventive taximeter using the navigation system includes a controller 10, a storage unit 20, a map database (DB) 30, an input unit 40, a touch screen 50, and a GPS module 60.

The controller 10 controls general operations of the navigation system and the taximeter. The storage unit 20 is comprised of a region for storing a control program for controlling the operations of the navigation system and the taximeter, a region for temporarily storing data generated in execution of the control program, and a user region for storing data generated by a user, such as a cap fare.

The map database 30 stores graphic map data on a terrain, a road, buildings on the road and a map, names of the terrain, the road, and the building, and a lot number.

The input unit 40 can employ a key input device including a fare calculation start key for generating a command of starting fare calculation, a fare calculation end key for generating a command of ending the fare calculation, and a plurality of keys for controlling the operations of the navigation system and the taximeter. The fare calculation start and end keys can be constituted of only a single key. In this case, the single key is alternately pressed, thereby repeating to start and end the fare calculation.

The touch screen 50 displays a plurality of information and map data depending on the operation of the navigation system, under the control of the controller 10, and displays the expected cap fare and the actual cap fare according to the present invention. The expected cap fare and the actual cap fare can be displayed together with the map data, or only the cap fares can be also displayed. In other words, when the cap fare is displayed, the map data cannot be displayed.

The GPS module 60 includes a gyro sensor for sensing an angle of direction, and a speed sensor for sensing a speed. The GPS module 60 receives each position information and absolute time information from a plurality of the GPS satellites, calculates the self position from the position information, and provides the calculated self position, the absolute time information, and the sensed direction angle and speed information to the controller 10.

The controller 10 receives the speed and time information from the GPS module 60, calculates a running distance and a running time based on the received speed and time information, calculates the cap fare based on the running distance and the running time, displays the calculated cap fare on the touch screen 50, and stores the calculated cap fare in the storage unit 20.

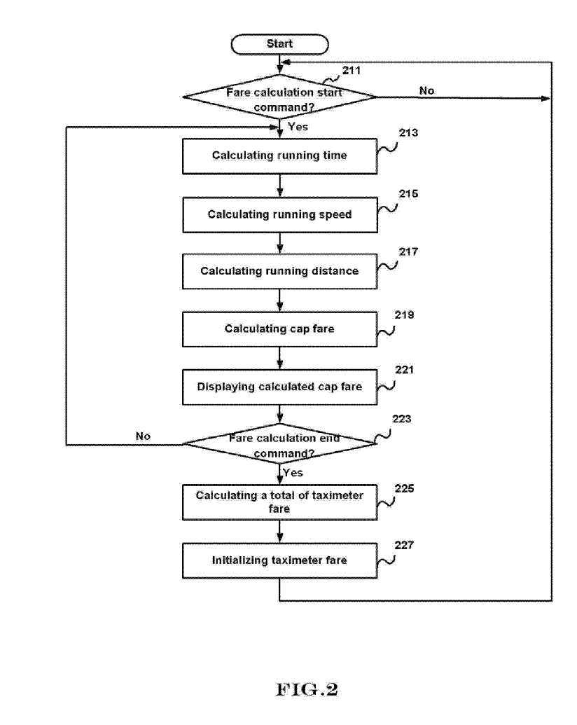

FIG. 2 is a flowchart illustrating a method for calculating the cap fare of the taximeter using the navigation system according to an embodiment of the present invention. A description thereof will be made with reference to FIGS. 1 and 2 below. A procedure of FIG. 2 can be performed together with or independently of a navigation operation. In case where the procedure of FIG. 2 is performed independently of the navigation operation, the navigation operation is terminated.

First, the controller 10 determines whether or not the cap fare start command is inputted from the input unit 40 in Step 211. If so, the running time and a running speed are calculated on the basis of the speed and absolute time information inputted from the GPS module 60 in Steps 213 and 215, respectively. After that, the controller 10 calculates the running distance based on the calculated running speed and running time in Step 217. After the calculating of the running distance, the controller calculates the cap fare according to a cap fare calculation method in Step 219. In general, the cap fare is calculated as a sum of a fare for an initial running distance, a fare per reference running distance after the initial running distance, and a fare for an excessive running time. After the calculating of the cap fare in Step 219, the controller 10 outputs and displays the calculated cap fare on the touch screen 50 being a display device in Step 221. At this time, the map data can be outputted and displayed on the touch screen 50 together, and the cap fare can be displayed at one side of the touch screen 50. Upon receipt of the cap fare start command in the Step 211, the navigation system can be activated only in a voice guide mode, and only the cap fare can be displayed on the touch screen 50.

After the cap fare is displayed, the controller 10 determines whether or not the fare calculation end command is inputted from the input unit 40 or the touch screen 50 in Step 223. If it is determined that the fare calculation end command is not inputted, the controller 10 repeats the Step 213 and its subsequent steps. In other words, until the fare calculation end command is inputted, the cap fare is updated and displayed. Upon receipt of the fare calculation end command in the Step 223, the controller 10 calculates a total cap fare of the taximeter in Step 225, and initializes the calculated cap fare of the Step 221 in Step 227. The total cap fare means a sum of all previous cap fares calculated through the Steps 211 to 223.

In the above, only a case where the actual cap fare is calculated and displayed is described. However, upon receipt of the fare calculation start command in the Step 211, the controller 10 can also receive the destination from a driver or a passenger and, after the Steps 213 to 217, calculate an expected running distance and an expected running time from an origin to the destination with reference to the map data, calculate the expected cap fare to the destination, and display the calculated cap fare on the touch screen 50.

As described above, the present invention has an advantage of not needing to install a high-priced taximeter needing separate sensor and measurement device, thereby reducing a cost.

Further, the present invention has an advantage of calculating the cap fare and the expected cap fare to the destination and displaying the calculated carp fare and expected cap fare to the taxi passenger using the navigation system, thereby improving passenger reliability and satisfaction.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A taximeter using a navigation system, the taximeter comprising:
a GPS (global positioning system) module having a speed sensor to measure a speed, and receiving position information and absolute time information from each of a plurality of GPS satellites, calculating a self position, and outputting the calculated position, the time information, and the speed;
a map database for storing map data;
an input unit for generating a fare calculation start command, a fare calculation end command, and character data;
a controller for mapping the calculated position to the map data, and upon receipt of the fare calculation start command, counting a time based on the time information, and accumulating a cap fare based on the counted time and the speed until receipt of the fare calculation end command; and
a display unit for displaying the accumulated cap fare.

2. The taximeter according to claim 1, wherein the controller receives a destination through the input unit, calculates an expected cap fare based on the counted time and the speed, and displays the expected cap fare on the display unit.

3. The taximeter according to claim 1, wherein upon receipt of the fare calculation start command, the controller displays the calculated cap fare and the mapped map data on the display unit.

4. The taximeter according to claim 2, wherein upon receipt of the fare calculation start command, the controller displays the calculated cap fare and the mapped map data on the display unit.

5. A method for calculating a cap fare of a taximeter using a navigation system having a GPS (global positioning system) module having a speed sensor to measure a speed, and receiving position information and absolute time information from each of a plurality of GPS satellites, calculating a self position, and outputting the calculated position, the time information, and the speed; a map database for storing map data; an input unit for generating a fare calculation start command, a fare calculation end command, and character data; and a display unit for displaying predetermined mapped map data and the accumulated cap fare, the method comprising the steps of:
upon receipt of a fare calculation command from the input unit, calculating a running time based on the counted time;
measuring a running speed through the GPS module;
upon measurement of the running speed, calculating a running distance based on the measured running speed and the counted time;
calculating a cap fare based on the running distance and the running time; and
displaying the calculated cap fare.

6. The method according to claim 5, further comprising the step of:
receiving destination information through the input unit, and calculating and displaying an expected cap fare to the destination based on the running time and the running distance.

7. The method according to claim 5, further comprising the step of:
upon receipt of the fare calculation end command, accumulating the cap fare on previous cap fares, and storing the accumulated cap fare.

8. The method according to claim 6, further comprising the step of:
upon receipt of the fare calculation end command, accumulating the cap fare on previous cap fares, and storing the accumulated cap fare.
